(19) United States
(12) Patent Application Publication
(10) Pub. No.: US 2026/0086031 A1
(43) Pub. Date: Mar. 26, 2026

(54) SIMULTANEOUS VIEWING OF SPREADING AND LEVELING

(71) Applicant: Wood Coatings Research Group, Inc., High Point, NC (US)

(72) Inventors: Ronald Todd Obie, High Point, NC (US); Cameron Ramil Anderson, Stoneville, NC (US)

(73) Assignee: Wood Coatings Research Group, Inc., High Point, NC (US)

(21) Appl. No.: 19/342,179

(22) Filed: Sep. 26, 2025

Related U.S. Application Data
(60) Provisional application No. 63/699,740, filed on Sep. 26, 2024.

(51) Int. Cl. G01N 21/47; G01N 21/49

(52) U.S. Cl. CPC G01N 21/4738; G01N 21/49; G01N 2201/0633

(57) ABSTRACT

Measuring of sample spreading and leveling is provided. Intensity of light reflected from a sample is measured in position and time, a first graphical image is generated representing sample flatness as a function of position, and a second graphical image representing sample spreading is generated as a function of time. Generating the first image includes identifying first locations corresponding to measured light intensity greater than or equal to the threshold value as representing flat sample portions, identifying second locations corresponding to measured light intensity less than the threshold value as representing non-flat regions of the sample or the substrate, and generating the first graphical image presenting the first and second locations differently. Generating the second graphical image includes identifying boundary positions of adjacent first and second locations at a plurality of times and generating the second graphical image presenting the identified boundary positions for at least two times.

### CROSS-REFERENCE TO RELATED APPLICATIONS

This application claims the benefit of U.S. Provisional Application. No. 63/699,740, filed on Sep. 26, 2024 and entitled “Simultaneous Viewing of Spreading and Leveling”, the entirety of which is hereby incorporated by reference.

### BACKGROUND

Spreading and leveling of coatings, liquids, and solidifiable liquid films (e.g., paints, stains, etc.) on an underlying substrate is an important aspect to subsequent appearance and/or protection of the substrate, and has been the focus of much academic and industrial research and development. Flow, wetting, and spreading behavior of a liquid film on a substrate typically involves the properties of the interface between the coating and substrate. Leveling behavior refers to the flowing out of, or smoothing of, surface irregularities (e.g., orange peel, brush marks, and unevenness) of a film or coating and can involve the interface between the liquid/film/coating and air.

Optimizing the flow and leveling of coatings is time consuming and typically involves trial-and-error experimentation. For example, aqueous-based coatings are particularly challenging to optimize due to the high surface tension of water.

### SUMMARY

A variety of methodologies have been developed to evaluate flow and leveling of paints and coatings. However, each of these methodologies have drawbacks.

In one example, the coating is applied to a substrate and then the final appearance after the coating has dried or cured is visually rated. In another example, the coating is applied to a substrate, and then physical or optical profilometry is performed on the dried or cured film. However, in each case, the coating is required to be dry before evaluating the flow and leveling of the coating. Thus, data regarding the kinetics of flow and leveling of the coating cannot be determined.

In a further example, researchers (e.g., Lelah and Marmur, “Spreading Kinetics of Drops on Glass”, J. Colloid Interface Science, 1981) have determined spreading kinetics of various liquid droplets on glass substrates by viewing the droplets from the bottom and determining the surface area of the droplet as a function of time. However, this technique is only able to measure spreading kinetics of the spreading liquid.

In another example, optical profilometers are capable of viewing samples from above. However, there are a variety of drawbacks to such instrumentation. Such drawbacks include the need for scanning in either of the in plane (x, y) directions and also in the height (z) directions of the objectives and table support. Furthermore, the time required to measure the optical profile of a sample can be long, e.g., approximately 1 minute or greater. Additionally, such equipment is typically extremely expensive to purchase.

Given the aforementioned deficiencies, a need exists for simultaneously viewing, measuring, and modeling spreading and leveling of substances such as coatings, liquids, or solidifiable liquid films. Examples can include, but are not limited to, stains, paints, or pigmented coatings. Further, there remains a need to measure data on spreading and leveling on millisecond time scales so that initial spreading and leveling behavior can be assessed. There also remains a need to accomplish such measurement(s) using techniques that are relatively simple, economical, and accurate.

As discussed in greater detail below, systems and methods utilizing light to simultaneously assess spreading and leveling behavior of liquids are provided.

In an embodiment, a method for applying coatings, liquids, or solidifiable liquid films (e.g., stains, paints, pigmented coatings, etc.) to a substrate and simultaneously determining its spreading and leveling behavior is provided. Sample droplets can be illuminated from the top utilizing coaxial or collimated lighting. Light reflected from the sample surface, the sample interior, or from the substrate associated with the area of the sample, can be detected using a detector and followed. Light that does not reach the detector results in that portion of the sample appears of low intensity, while light that reaches the detector from the sample reflections in that portion of the sample appears of higher intensity. The resulting detected intensity is a function of the radius of curvature of the sample droplet. Areas of high radius of curvature display as dark by the detector, while areas of low or flat radius of curvature relative to the illumination and detection angle display as higher intensity. Because the periphery of the droplet always has a high radius, regardless of state of flatness of the sample, this periphery will always appear dark to the detector whether wet or dry, allowing the change in diameter or area of the periphery of the sample to be followed. As the droplet levels out, more light is detected by the detector due to favorable reflections of the sample. Therefore, as the sample levels out, the area of these favorable reflections may be followed by the detector. Thus, both the darkness and lightness transition of the spreading droplet can be simultaneously followed.

In an embodiment, a system for measuring sample spreading and leveling is provided. The system includes a substrate, an illumination source, a detector, a processor, and a display. The substrate can be configured to receive a sample. The illumination source can be configured to generate light incident upon a region of the substrate including the received sample. The detector can be configured to measure intensity of the generated light that is reflected as a function of position and time. The processor can be configured to receive the measured light intensity, generate a first graphical image representing flatness of the sample as a function of position, and generate a second graphical image representing spreading of the sample as a function of time. The first graphical image can be generated by comparing the measured intensity to a predetermined light intensity threshold value, identifying first locations corresponding to measured light intensity that is greater than or equal to the predetermined light intensity threshold value as representing flat regions of the sample or substrate, identifying second locations corresponding to measured light intensity that is less than the predetermined light intensity threshold value as representing non-flat regions of the sample, and generating the first graphical image presenting the first locations in a first color or pattern and the second locations in a second color or pattern different from the first color or pattern. The second graphical image can be generated by identifying boundary positions at which the first and second locations are adjacent to one another at a plurality of times, and generating the second graphical image presenting the identified boundary positions for at least two of the plurality of times. The a display can be configured to display at least one of the first and second graphical images.

In another embodiment of the system, the detector can be configured to measure the light intensity along a line oriented at a predetermined angle with respect to a plane of the substrate.

In another embodiment of the system, the processor can be further configured to generate second graphical image representing the measured boundary as a function of position along the line.

In another embodiment, the system can further include a profilometer configured to measure a profile of the sample along the line and the processor can be further configured to receive a profile measurement of the sample along the line and generate the second graphical image including the measured profile and the measured boundary.

In an embodiment, the system further includes a contact angle goniometer configured to measure a contact angle of the received sample concurrently with the measurement of light intensity.

In an embodiment of the system, the illumination source includes at least one microlens array, the at least one microlens array being positioned in an optical path of the generated light or in an optical path of the reflected light.

In another embodiment of the system, an angle of incidence of the incident light with respect to a normal of the substrate is within the range of about 0 degrees to 50 degrees.

In another embodiment of the system, the light has a wavelength within the range from about 380 nm to about 800 nm.

In another embodiment of the system, the light detector is a camera.

In another embodiment of the system, the generated light is collimated.

In another embodiment of the system, the generated light is coaxial.

In another embodiment, the system further includes a first objective lens positioned in an optical path of the generated incident light and a second objective lens positioned in an optical path of the reflected light.

In another embodiment, the system further includes a single objective lens positioned in an optical path of the generated incident light and an optical path of the reflected light.

In an embodiment, a method for measuring sample spreading and leveling is provided. The method includes generating, by an illumination source, light incident upon a region of a substrate including a sample received thereon. The method further includes measuring, by a detector, intensity of the generated light that is reflected as a function of position and time. The method additionally includes receiving, by a processor, the measured light intensity. The method further includes generating, by the processor, a first graphical image representing flatness of the sample as a function of position and generating, by the processor, a second graphical image representing spreading of the sample as a function of time. Generating the first graphical image includes \comparing the measured intensity to a predetermined light intensity threshold value, identifying first locations corresponding to measured light intensity that is greater than or equal to the predetermined light intensity threshold value as representing flat regions of the sample or substrate, identifying second locations corresponding to measured light intensity that is less than the predetermined light intensity threshold value as representing non-flat regions of the sample, and generating the first graphical image presenting the first locations in a first color or pattern and the second locations in a second color or pattern different from the first color or pattern.

Generating the second graphical image includes identifying boundary positions at which the first and second locations are adjacent to one another at a plurality of times and generating the second graphical image presenting the identified boundary positions for at least two of the plurality of times. The method additionally includes displaying, by a display, at least one of the first and second graphical images.

In another embodiment, the method includes acquiring the measured intensity along a line oriented at a predetermined angle with respect to a plane of the substrate.

In another embodiment, the method includes generating, by the processor, the second graphical image representing the measured boundary as a function of the position along the line.

In another embodiment, the method includes measuring, by a profilometer, a profile of the sample along the line and generating, by the processor, the second graphical image including the measured profile and the measured boundary.

In another embodiment, the method further includes measuring, by a contact angle goniometer, a contact angle of the received sample concurrently with the measurement of light intensity.

In another embodiment of the method, an angle of incidence of the incident light with respect to a normal of the substrate is within the range of about 0 degrees to about 50 degrees In another embodiment of the method, the light has a wavelength within the range from about 380 nm to about 800 nm.

Various embodiments are discussed herein. Any of the embodiments can be used alone or in combination with one or more of the other embodiments. Some of the combinations can be employed to formulate coating compositions having unexpected properties in view of the state of the art, and are intended to be encompassed within the scope of the disclosure. Additional objects and advantages of the disclosed embodiments are discussed in the detailed description that follows. It is to be understood that this summary and the following detailed description are exemplary and explanatory only, and are not intended to restrict the scope of the disclosed embodiments.

### BRIEF DESCRIPTION OF THE DRAWINGS

These and other features will be more readily understood from the following detailed description taken in conjunction with the accompanying drawings, in which:

FIG. 1A is a schematic diagram illustrating a first embodiment of a system for measuring spreading and leveling of a sample, including a pair of objective lenses.

FIG. 1B is a schematic diagram illustrating a second embodiment of a system for measuring spreading and leveling of a sample, including a common objective lens.

FIG. 2 is a schematic diagram illustrating light illumination and reflections of a spherical sample.

FIG. 3 is a schematic diagram illustrating light illumination and reflections of a sample having a flat surface.

FIG. 4 is an image illustrating an initial appearance of a deionized (DI) water droplet utilizing the measurement system of FIG. 1.

FIG. 5 is an image illustrating a final optical appearance of a sample according to Example 1 discussed herein.

FIG. 6 is a plot illustrating physical and optical profiles of the sample of Example 1 after complete drying.

FIG. 7 is an image illustrating a final optical appearance of a sample according to Example 2 discussed herein.

FIG. 8 is a plot illustrating physical and optical profiles of a sample according to Example 2 after complete drying.

FIG. 9 is a plot illustrating simultaneous measurement and modeling of spreading and leveling of the sample according to Example 1.

FIG. 10 is a plot illustrating simultaneous measurement and modeling of spreading and leveling of the sample according to Example 2.

FIG. 11 is flow diagram of a method of measuring spreading and leveling of a sample employing the system of FIG. 1A or 1B.

It is noted that the drawings are not necessarily to scale. The drawings are intended to depict only typical aspects of the subject matter disclosed herein, and therefore should not be considered as limiting the scope of the disclosure.

### DETAILED DESCRIPTION

As mentioned above, embodiments of the present disclosure may be more readily understood by referring to the description and figures. It is to be understood that embodiments of the present disclosure are not limited to the specific apparatus, processes, procedures, and/or process conditions for applying stain and coating materials discussed herein, as they may vary for specific liquids and require certain specific formulations, apparatus and processes and/or process conditions.

As discussed herein, the term viscosity adopts its ordinary and customary meaning and can refer to resistance of a liquid to flow.

As discussed herein, the term complex viscosity adopts its ordinary and customary meaning and can refer to the viscous response of a liquid or solid material, such as a frequency-dependent viscosity function determined during forced harmonic oscillation of shear stress.

As discussed herein, the term rheology adopts its ordinary and customary meaning and can refer to the science of deformation and flow of matter.

As discussed herein, the term viscoelastic adopts its ordinary and customary meaning and can refer to the behavior of all real materials displaying both viscous and elastic behavior during deformation. Viscous behavior can be time-dependent (liquid-like), while elasticity is not time dependent (solid-like behavior). Viscoelasticity can be numerically characterized for both liquid materials as well as solid materials.

As discussed herein, the term storage modulus adopts its ordinary and customary meaning and can refer to solid-like behavior of a liquid or solid material.

As discussed herein, the phrase collimated beam of light or collimated electromagnetic beam adopts its ordinary and customary meaning and can refer to a beam of light or other electromagnetic radiation in which the light or electromagnetic radiation is characterized as rays that are approximately parallel and spread minimally (e.g., a maximum angular deviation of the rays true parallel with respect to one another is less than a predetermined angle).

As discussed herein, the phrase coaxial beam of light or electromagnetic radiation adopts its ordinary and customary meaning and can refer to a beam of light or electromagnetic radiation in which the intensity of the light or electromagnetic radiation that substantially uniformly illuminates an area extending perpendicular to a detector axis of a light detector. For example, across an entire field of view of the light detector. That is, respective light rays extend approximately parallel to the axis of the light detector.

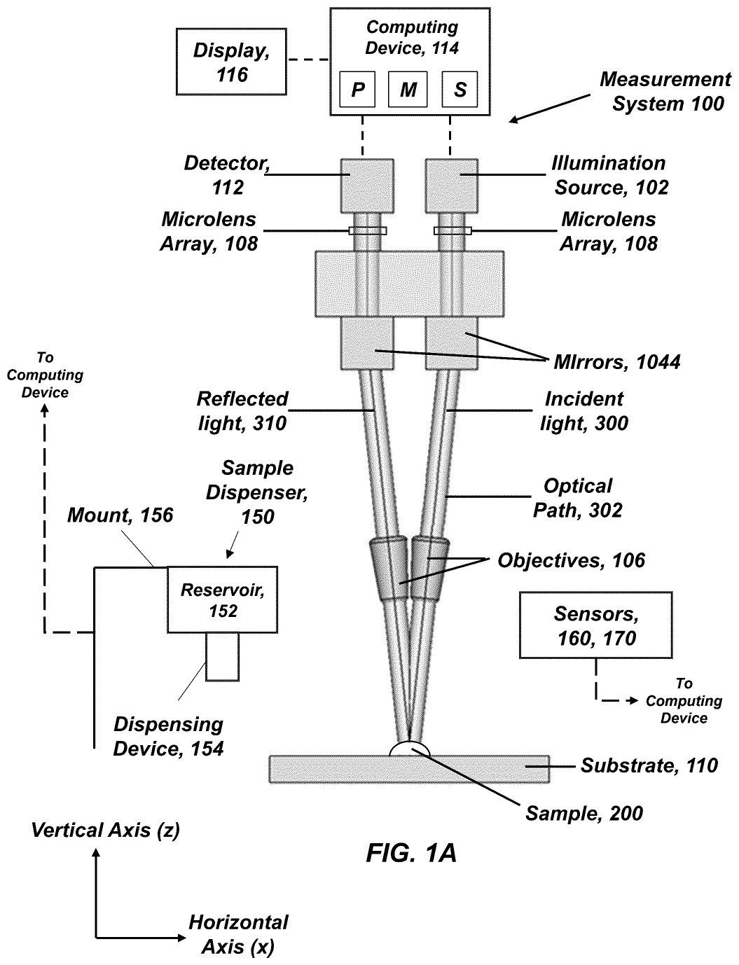

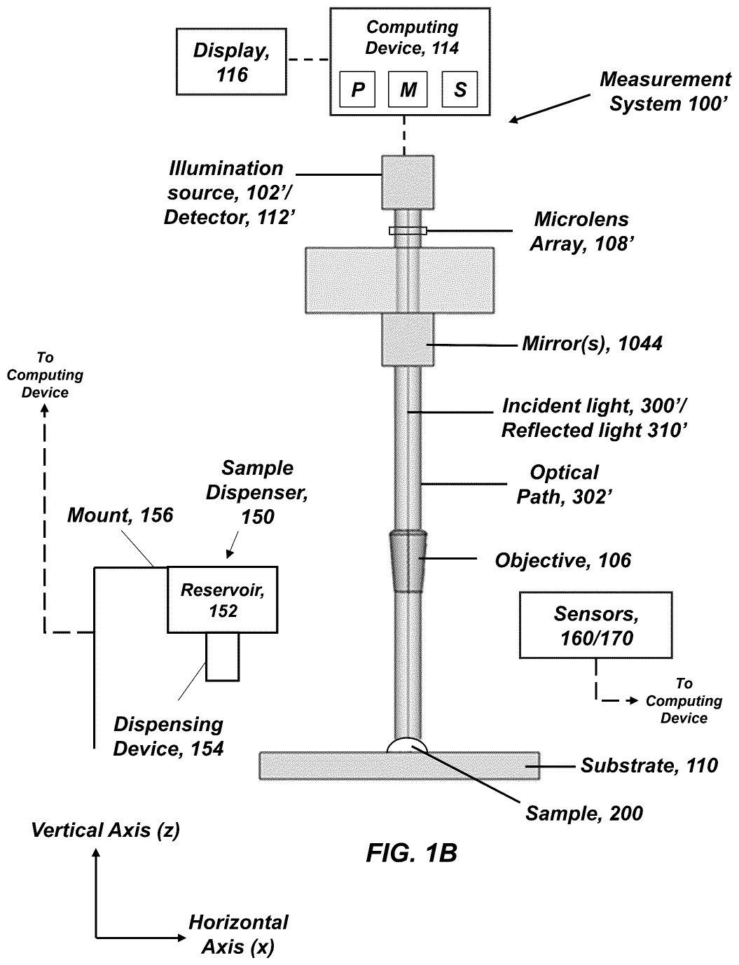

A measurement system 100 for measuring spreading and leveling behavior is illustrated with reference to FIG. 1A. As shown, the measurement system 100 includes an illumination source 102, a plurality of mirrors 104 (e.g., prisms, beam splitters, etc.), a plurality of objective lenses 106, a substrate 110, a detector 112, and a computing system 114.

The substrate 110 can be formed from any material suitable for support of the sample 200 thereon. Examples can include, but are not limited to, wood, plastic, metal, glass, concrete, paper, cloth, or vinyl. A surface of the substrate 110 facing the sample 200 can be coated (e.g., a paint, a coating, a liquid, a powder, film, a solid, a colorant, a chemical, etc.)

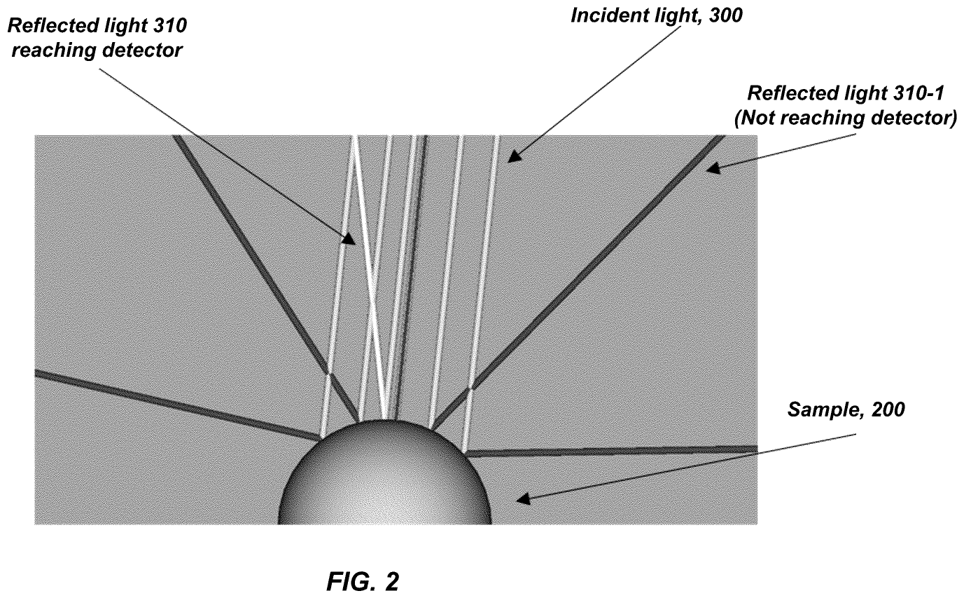

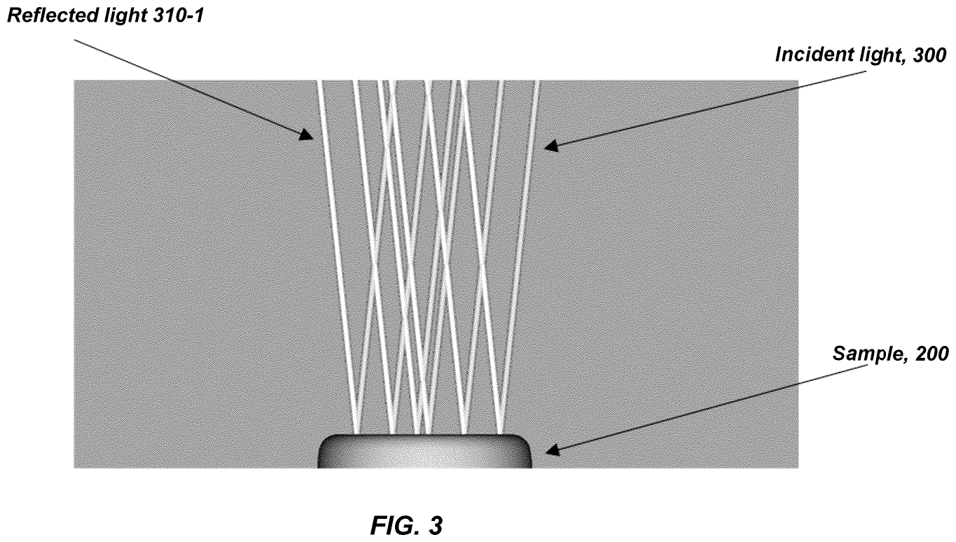

Further referring to FIGS. 1-3, light 300 from the illumination source 102 is incident upon a sample 200 that has been applied to the substrate 110 and is subsequently reflected as reflected light 310. For example, one of the mirrors 104 and objectives 106 is placed in an optical path 302 of the incident light 300 to direct/focus the incident light 310 upon the substrate 110 at a predetermined angle of incidence. The angle of incidence (or illumination angle) of the incident light 300 upon the sample 200 is a predetermined angle from the direction normal (perpendicular) to the surface of the substrate 110. The predetermined angle can be within the range between about 0 degrees to about 50 degrees. In further embodiments, the predetermined angle is a non-zero angle. For example, the predetermined angle can be about 6 degrees from the direction normal (perpendicular) to the surface of the substrate 110.

As further shown in FIGS. 1A, 2-3, the reflected light 310 can be classified into one of two groups, reflected light 310-1 that is reflected into the detector 112 and reflected light 310-2 that is reflected away from the detector 112. When the surface of the sample 200 is flat (planar), the angle of incidence is equal to the angle of reflection. Accordingly, another objective 106 and mirror 104 are positioned to direct the optical path of reflected light 310 having an angle of reflection equal or approximately equal to the angle of reflection to the detector 112. That is, the detection angle is configured to be equal or approximately equal to the angle of incidence.

The detector 112 detects intensity of light 310-1 reflected into the detector 112 from a given point on the sample 200 as being higher than the light 310-2 which is reflected away from detector 112. When the surface of the sample 200 is flat (planar), the angle of incidence is equal to the angle of reflection. Accordingly, another objective 106 and mirror 104 are positioned to direct the optical path of reflected light 310 having an angle of reflection equal or approximately equal to the angle of reflection to the detector 112. That is, detection of the light 310-1 indicates that the surface of the sample 200 is relatively flat, and the greater the intensity of light 310-1 detected by detector 112, the greater an area of flatness of the surface of sample 200.

The detector 112 can be a light detector (e.g., a camera) having a relatively high frame rate (e.g., greater than 24 frames per second (fps)). Images of the reflected light 310 from the sample 200 are captured as a function of time. The light detector can be a camera. For example, the camera can include a CCD or CMOS image sensor to sense light intensity.

The detector 112 can be in communication with the computing system 114. The computing system can include at least one processor P, at least one memory M, and at least one storage S. The detector 112 can transmit captured images for receipt by the computing system 114 for storage (e.g., by the memory M and/or the storage S) for further analysis by the processor P, discussed below. The computing system 114 can be in further communication with a computer display device 116. Analysis results generated by the processor P can be stored in the memory M and/or storage S, as well as output to the display 116.

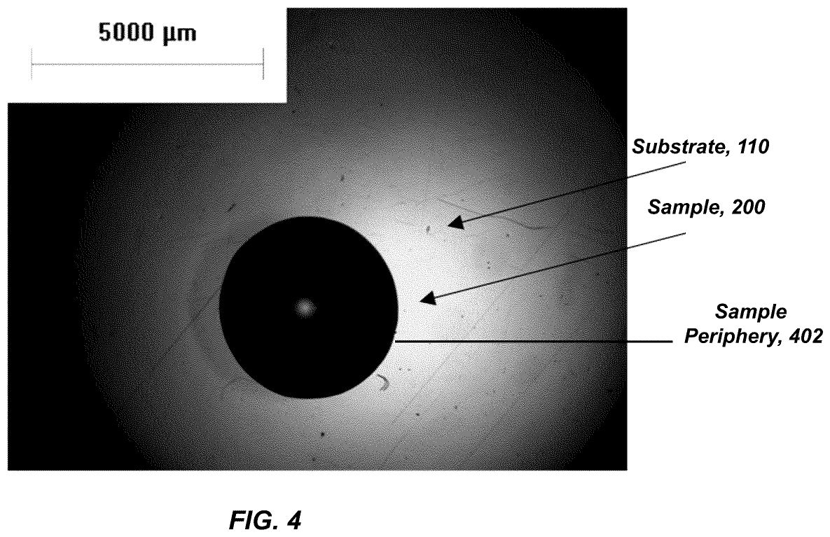

FIG. 4 shows an example captured image 400 of a sample 200 that is deionized (DI) water. One or more of the captured images is analyzed by the processor using image analysis to determine an amount of high intensity light (light having an intensity greater than or equal to the predetermined light intensity threshold value) that is captured by the light detector 102 and an amount of low intensity light (light having an intensity lower than the predetermined light intensity threshold value) that is captured by the light detector 112 from illumination of the sample 200 by the illumination source 102. Because higher intensity light only results due to reflection from relatively level surfaces (surfaces lying within a plane extending approximately parallel to a horizontal (x) axis), the area associated with leveling of surface of sample 200 may be obtained.

The substrate 110 can be flat or approximately flat and have a surface that is reflective. For example, the substrate 110 can have a surface exhibiting a reflectivity greater than or equal to a predetermined value. As discussed above, measured light intensity reflected from regions high radius of curvature of the sample 200 (e.g., at the periphery of the sample 200) is relatively low, while measured light intensity reflected from regions of low radius of curvature (e.g., flat regions of the sample 200 or the substrate) is relatively high. This provides contrast between the periphery of the sample 200 and the substrate 110, allowing identification of the boundary of the sample 200. Identification of the boundary at a series of different times allows for characterization of the spreading of the sample 200.

The light intensity detected by the detector 112 from light 300-1 at different positions on the sample 200 can be compared to a predetermined light intensity threshold value. Light intensity greater than or equal to the predetermined light intensity threshold value can be identified as associated with a flat region of the sample 200, while light intensity less than the predetermined light intensity threshold value can be identified as associated a region of the sample 200 that is not flat.

Because the periphery of sample 200 is always curved, this area will exhibit relatively low measured light intensity. The substrate 110 can be flat or approximately flat and have a surface that is reflective, exhibiting relatively high measured light intensity. For example, the substrate 110 can have a surface exhibiting a reflectivity greater than or equal to a predetermined value. This difference in measured light intensity between the periphery of the sample 200 and the substrate 110 provides contrast that allows the periphery 402 of the sample 200 to be identified as a function of time with great clarity, providing spreading area of the sample 200.

In an embodiment, the measurement system 100 can employ a Greenough optics design for light illumination and detection. As illustrated in FIG. 1A, the measurement system 100 can include dual and symmetrical optical systems (e.g., dual mirrors 104, dual objective lenses 106) arranged along the optical path 302 of incident light 300 and reflected light 310 (310-1). For example, an illumination angle of about 6 degrees from normal to the substrate 110 can be employed. Accordingly, in an embodiment, a detection angle of about 6 degrees from normal can also be employed. It can be appreciated, however, that further embodiments can utilize a variety of different illumination and/or detection angles, as necessary. For example, a plurality of illumination sources and/or detectors can be employed. In further embodiments, a microlens array can be utilized in conjunction with the illumination source and/or the detector to increase light generation and light collection efficiency.

An alternative embodiment of a system for measuring spreading and leveling of a sample 100′ is illustrated in FIG. 1B. The system 100′ includes a common main objective 106′. The illumination source 102′ single objective 106′ and mirror(s) 104′ can be configured to such that the optical path of incident light 300′ and reflected light 310′ directed to the detector 112 is coaxial. That is, the angle of incidence and angle of reflection are zero degrees or approximately zero degrees. Optionally, the system 100′ can employ one or more microlens array(s) 108′.

The illumination source 102 can adopt a variety of configurations. Examples can include, but are not limited to, light emitting diodes (LEDs), halogen lights, incandescent lights, fluorescent lights, etc. In an embodiment, the illumination source 102 is a halogen lamp.

In an embodiment, the illumination source 102 emits white light. The white light can be characterized as having a wavelength within a predetermined range (e.g., within the range of wavelengths corresponding to white light; from about 380 nm to about 800 nm) or a color temperature within a predetermined range (e.g., within the range from about 2700 k to about 6500 k). For example, the illumination source 102 can be an LED light source that emits white light.

In an embodiment, the illumination source 110 employs coaxial illumination illuminate the sample 200.

In an embodiment, the mirror(s) 104, 104′ can include mirror assembly configured to the keep view of the sample erect. In alternative embodiments, prisms can be used to keep the view of the sample 200 erect.

In further embodiments, the sample 200 can be dispensed on the substrate 102 in a variety of ways. In one aspect, the sample 200 can be manually dispensed (e.g., using a pipet, needle, syringe, etc.)

In another aspect, the sample 200 can be dispensed using a computerized or robotic dispensing device. For example, the system 100 can further include a sample dispenser 150 including a reservoir 152 and a dispensing device 154 (e.g., a nozzle, needle, etc.) secured to actuatable mount 156 (e.g., an articulatable arm configured to move in x, y, and z directions with respect to the substrate 110).

In another embodiment, the sample 200 (e.g., a coating material) can be dispensed through tubing using a pump. The dispensing device 150 can take the form of a pump in fluid communication with a tube secured to the mount 156. In an example, the pump can be a peristaltic pump. However, embodiment of the disclosure can employ other types of pumps that are capable of transferring liquid or material. Examples of such pumps can include, but are not limited to, positive displacement pumps, such as single action, dual action, or glutton types; centrifugal, gear, or rotary vane types; or diaphragm, or progressive cavity types, for instance. In one embodiment a syringe pump is utilized to dispense sample 200.

The computing device 114 can be in communication with the dispensing device 150 and/or the actuatable mount 156. The mount 156 can include two or more sections that can be translated and/or rotated with respect to each other. In one example, the mount 156 can be manually articulated to position the sample dispenser 150 at a designated location with respect to the substrate 110. In another example, the mount 156 can include one or more motors in communication with the computing device that are configured to articulate (e.g., translate and/or rotate) respective portions of the sample dispenser 156 in response to commands received from the computing device 114. These commands can position the sample dispenser 156 at the designated location with respect to the substrate 110.

So positioned, the dispensing device 156 can be further configured to dispense the sample 200 on the substrate 110. The sample 200 can be dispensed by using manual control by an operator or in response to commands received from the computing device 114 (e.g., using a hydraulically actuated dispensing device in communication with a pressure source controlled by commands from the computing device 114). After the sample is dispensed, the sample dispenser 150 can be further moved to a home or resting position to avoid obstructing incident light 300 or reflected light 310.

In further embodiments, the amount of sample 200 dispensed (e.g., mass, volume) can be measured by a sensor in communication with the sample dispenser 150. In one example, the dispensing device can include a flow meter configured to measure a volume of dispensed sample. In another embodiment, the substrate 110 can be coupled to a load cell to measure the mass of dispensed sample 200. Knowing the density of the sample 200, the volume of dispensed sample 200 can be further calculated from the measured mass.

In other embodiments, the sample 200 can be dispensed using control feedback. For example, the dispensing device 150 and sensor can be in communication with the computing device 114. The computing device can receive input (e.g., user input, input from a computer file, etc.) regarding a desired amount of sample to be dispensed (e.g., mass or volume). The computing device 114 can receive measurement of the volume and/or mass of sample applied to the substrate 110 from the sensor and command the dispensing device 154 to dispense the sample 200 until the desired amount is reached.

In additional embodiments, the testing environment can be varied. For example, controlled atmospheric testing conditions can be achieved by control of one or more environmental parameters, alone or in any combination. Such environmental parameters can include, but are not limited to, temperature, humidity, and/or gravity. For example, testing can be performed in room capable of controlling the one or more environmental parameters. Alternatively, a chamber capable of controlling the one or more environmental parameters can be built into the testing apparatus.

In an embodiment, an algorithm can be utilized for image analysis and data handling. In further embodiments, the testing and evaluation can employ high throughput experimentation methods and techniques, alone or in combination with artificial intelligence and/or machine learning incorporated into.

In further embodiments, variety of other techniques can be employed to visualize sample 200, besides a top view. For example, a horizontal view of sample 200 can be utilized as well as a top view in the same experiment. For example, the illumination source, detector, lenses, and mirrors of the measurement system can be configured such that the optical path of incident light and reflected light is in a horizontal direction with respect to the substrate (e.g., parallel to the surface of the substrate).

In additional embodiments, the top view experiment may be run in concert with a contact angle goniometer. The contact angle goniometer may be an entirely separate instrument or measurement, or it may be built into the functionality of the instrument or measurement.

In another embodiment, dispensing the sample 200, measurement(s) of the sample 200, and/or data processing of measurements can be automated. For example, the system 100 can employ an automated sample dispenser as discussed above. In response to commands from the computing device 114, the sample 200 can be automatically dispensed on the substrate 114. Subsequently, in response to further commands from the computing device, 114, the illumination source 102 can generate light and the detector 112 can measure and store intensity of the reflected light 320. The processor P can further analyze the measured intensity upon receipt or in response to further commands from the computing device 114.

In further embodiments, intensity measurements can be acquired at one or more locations of the sample 200. That is, the position of the sample 200 can be changed with respect to the incident light 300 during measurements. In one example, the substrate 200 may be moved in x, y, and/or z directions with respect to the incident light 300. Such movement can be performed under manual or autonomous control. So configured, measurements of intensity of reflected light 320 can be acquired along lines having various angles with respect to the sample 200 and/or defined areas with respect to the sample 200. Beneficially, data that is measured, acquired, and calculated according to the embodiments herein can allow for modeling of spreading and leveling behavior of the dispensed sample 200.

In further embodiments, the measurement system 100 can include one or more first sensor(s) 160 which are utilized in combination with the computing device 114 to properly dispense the sample 200. In one embodiment, a sonar sensor can be utilized to detect the beginning and ending edge of the substrate 110 that is to be coated, as well as the height of the substrate 110. In another embodiment an electro-optical sensor can be utilized to detect the beginning and ending edge of the substrate 110 to be coated, as well as the height of the substrate 110.

One or more second sensors 170 may be utilized to dispense, test, and measure the spreading and leveling of the sample 200. The selection of second sensor(s) 170 can depend upon the particular target application. Examples of second sensors 170 can include, but are not limited to, angle, gyro, infrared (IR), light detection and ranging (LIDAR), 3D laser scanning, optical encoders, rotary shaft encoders, sensors based on photoelectric scanning principles (inclusive of scanning principle and interferential scanning principle), linear variable differential transformer (LVDT), force, compass, touch, color, light, magnetic, proximity sensors, temperature, humidity or sensors. Sensors and mechanisms may also include those included in Patent Publication No. 2022/0397424, the entirety of which is incorporated herein by reference.

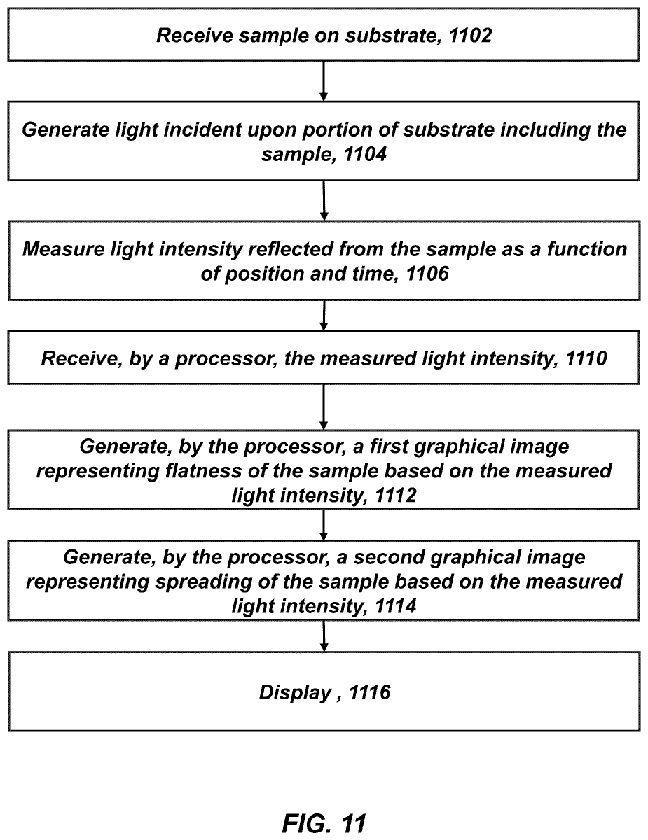

FIG. 11 illustrates an embodiment of a method 1100 for measuring sample spreading and leveling.

In operation 1102, the sample 200 is received on the substrate 110. As discussed above, the sample 200 can be deposited manually or in an automated manner under control of the computing device 114. In certain embodiments, deposition of the sample 200 can be performed using the sample dispenser 150, manually in an automated manner. In further embodiments, the amount of the sample 200 that is deposited can be controlled by feedback control using the sample dispenser 150.

In operation 1104, light 300 generated by the illumination source 102 is incident upon a region of the substrate 110 including the dispensed sample 200. The wavelength of light 300 can be within the range of wavelengths corresponding to white light (e.g., between about 380 nm to about 800 nm). However, in other embodiments, the wavelength of light can adopt other wavelengths, as necessary.

The incidence of the light 300 upon the substrate can be controlled. In one aspect, the angle of incidence can be controlled to adopt a value within a predetermined range with reference to a normal to the surface of the substrate 110. For example, at least one of the mirror(s) 104/104′ or objectives 106/106′ can be configured such that the optical path 302/302′ of the incident light 300/300′ is directed at a desired angle of incidence.

In another aspect, the location of the sample 200 upon which the light 300 is incident can be controlled. For example, the light 300 can be focused to a point or spot that is moved in a desired pattern (e.g., a line, a plurality of lines, etc.) with respect to the sample 200 (e.g., by movement of the substrate 110 with respect to the light 300 or by movement of the light 300 with respect to the substrate 110).

In another example, multiple lights can be employed and focused in a line, area, or other pattern. Optionally, such multiple lights can be implemented using a microlens array 108.

In operation 1106, the detector 112 measures the intensity of light 310 that is reflected from the sample 200 as a function of position and/or time. At least one of the mirror(s) 104/104′ or objectives 106/106′ can be configured such that the optical path 302/302′ of the reflected light 310/310′ (reflected light 310-1) along an angle of reflection equal or approximately equal to the angle of incidence is directed to the detector 112. In an embodiment, a microlens array 108 can be employed with the detector 112 to facilitate light collection.

In operation 110, the measured light intensity is received by the processor P. The received measured light intensity can be received directly from the detector 112, received from the memory M, received from the storage S, or any combination thereof.

In operation 1112, a first graphical image representing flatness of the sample 200 can be generated based on the measured light intensity. For example, the measured light intensity can be compared to a predetermined light intensity threshold value. The predetermined light intensity threshold value can be obtained by the processor from operator input, retrieved from the memory M, retrieved from the storage S, or any combination thereof. Locations corresponding to measured light intensity that is greater than or equal to the predetermined light intensity threshold value are identified as representing flat or approximately flat regions of the sample 200 or substrate. Locations corresponding to measured light intensity that is less than the predetermined light intensity threshold value are identified as non-flat regions of the sample 200.

The first graphical image can present the first locations in a first color or pattern and the second locations in a second color or pattern. The first and second colors or patterns are different from one another to distinguish between the first locations representing the flat region of the sample 200 or the substrate and the second regions representing the

[symbol]

In operation 1114, a second graphical image representing spreading of the sample 200 can also be generated based on the measured light intensity. For example, boundary positions at which the first and second locations are next to one another can be identified at a plurality of times. For example, the processor P can identify intensity data corresponding to adjacent locations on the sample 200 where the measured light intensity at one of the adjacent locations is greater than or equal to the predetermined light intensity threshold value and the other of the adjacent locations is less than the predetermined light intensity threshold value. In one embodiment, one of these adjacent locations can be selected as a boundary location. This process can be repeated for at least a portion of the measured intensity data to define a plurality of boundary locations representing spread of the sample 200 at the time of measurement. In certain embodiments, boundary locations between measured intensity data can be interpolated. This process can be repeated for different measurement times.

When the sample 200 is in the process of flattening, a flat region of the sample 200 can be surrounded by a curved (non-flat) region of the sample 110, representing a first boundary. The curved region of the sample can be further surrounded by the substrate 110, representing a second boundary. The region within an innermost of the two boundaries characterizes the flat region of the sample 200. Therefore, the flattening behavior of the sample over time can be followed from the innermost of the two boundaries. The outer periphery of the sample 200 can be understood to be characterized by the outermost of the two boundaries. Therefore, the spreading behavior of the sample 200 over time can be followed from the outermost of the two boundaries.

The second graphical image can present the identified boundary positions for the different measurement times to characterize spreading of the sample 200. In one example, the identified boundary positions can be represented as different lines within the second graphical image, where each line represents a different time. In another example, the second graphical image can represent boundary spreading at a selected location as a function of time. In this case, the second graphical image can be a scatter or line plot of boundary position on one axis (e.g., a vertical axis) and corresponding time on a second axis (e.g., a horizontal axis).

In operation 1116, at least one of the first and second graphical images can be displayed by the display 116. The display 116 can receive the one or more first and second graphical images from the computing device 114.

### EXAMPLES

### Example 1

A stainless steel container, equipped with a Cowles blade, was charged with 46.83 g mineral spirits, 0.37 g xylene, 0.07 g Skino #2 (OMG, Westlake Ohio), 0.18 g TegoGlide 496 (Evonik, Hopewell VA), 0.03 g West dry Cobalt 12% (Westbridge Industries), and 71.19 g Urotuf F78-X-50 (Polynt Group, Carpentersville (Illinois)—USA was added under agitation. The material was mixed until smooth.

### Example 2

A stainless steel container, equipped with a Cowles blade, was charged with 1406.69 g of an aqueous self-crosslinking polyurethane dispersion having a Koenig hardness of about 115. A separate stainless steel container, equipped with a propeller blade, was charged with 274.72 g deionized (DI) water, 44.03 g dipropylene glycol methyl ether, 3.48 g Rheovis PU 1214 EC (BASF, Charlotte NC). The blend was mixed for 10 minutes at 1000 rpm. The contents of the second container were then added slowly to the first container while under agitation at 700 rpm, and the blended materials mixed for 15 minutes. To the blended, mixed sample was added 1% of an anionic short chain fluoro-surfactant and the sample was mixed for about 10 minutes.

### Example 3

A small droplet of a sample fabricated according to Example 1 (less than or equal to 30 μL) was applied to a polyester substrate (PC300-7C from Leneta Company, Mahwah, NJ). Spreading and leveling of the droplet was followed, as a function of time, by following the area of higher intensity light in captured images and the area of low intensity of the same images utilizing the apparatus and principles illustrated and discussed above with regards to FIGS. 1-3.

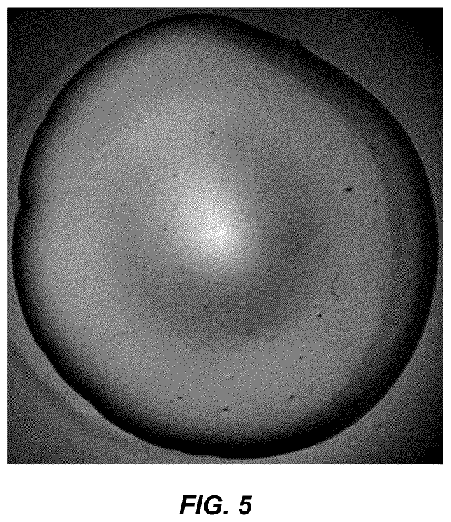

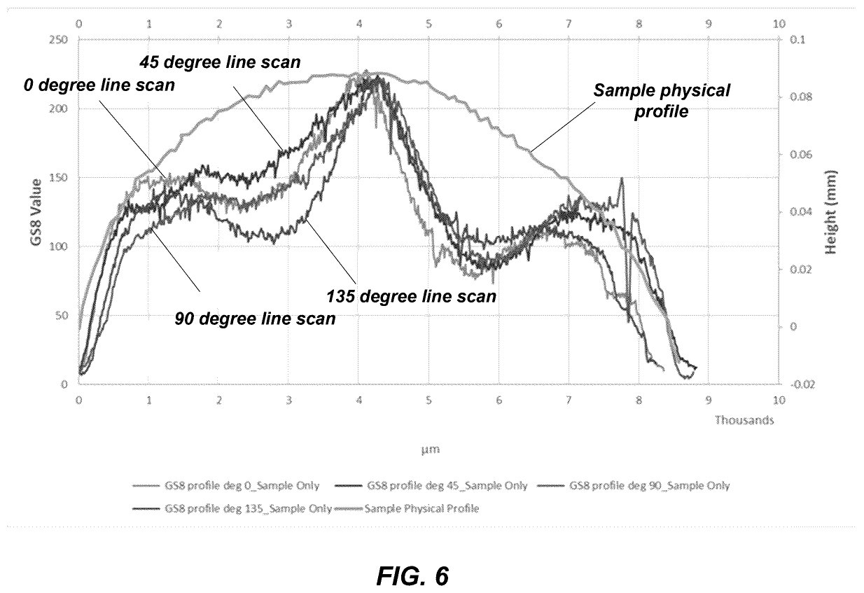

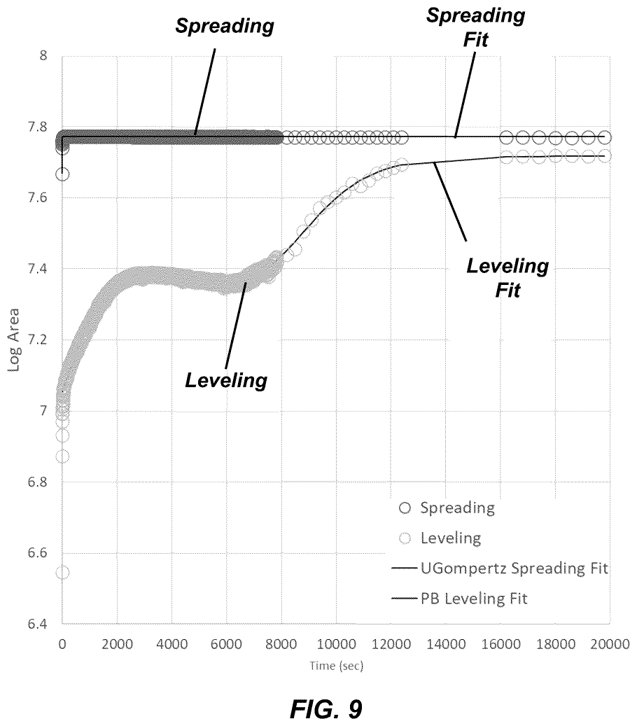

FIG. 5 is the final image obtained for the measurement after 19788 seconds drying time. FIG. 6 is a plot presenting a physical profile of the dried droplet (dome shaped curve) and intensity measurements of 4 line scans across the image, at 0, 45, 90, and 135 degrees across the image. FIG. 9 is a resulting plot of the data obtained from the experiment. The blue curve (top, open circles) represents sample spreading; the yellow curve (bottom, open circles) represents sample leveling. The solid lines overlaid onto the data represent modeling fits to the data.

### Example 4

A small droplet of a sample manufactured according to Example 2 (less than or equal to 30 μL) was applied to a polyester substrate (PC300-7C from Leneta Company, Mahwah, NJ). Spreading and leveling of the droplet was followed, as a function of time, by following the area of higher intensity light in captured images and the area of low intensity of the same images utilizing the apparatus and principles illustrated and discussed with regards to FIGS. 1-3.

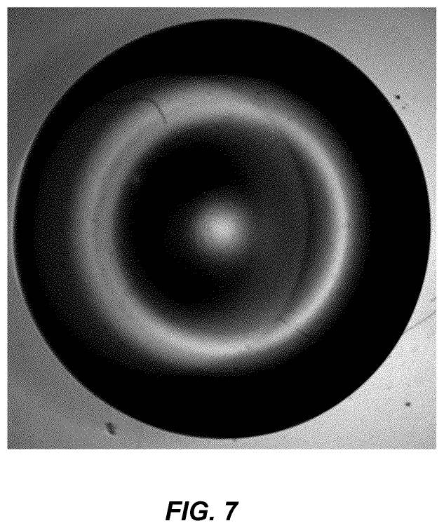

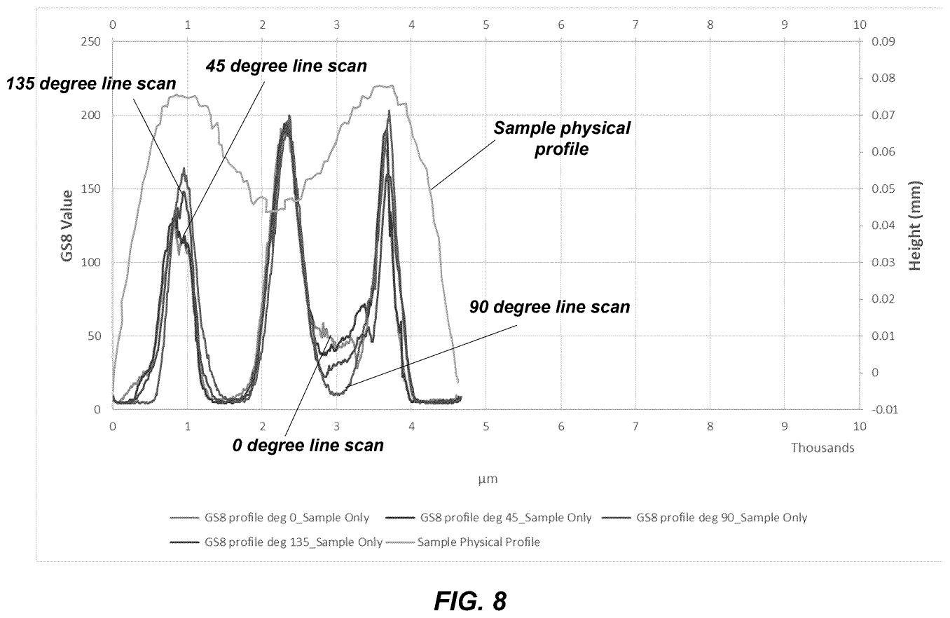

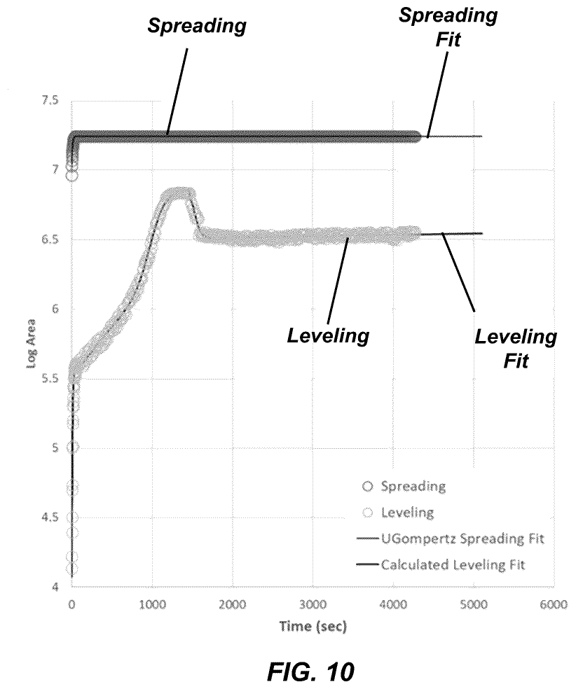

FIG. 7 is the final image obtained for the measurement after 5104 seconds drying time. FIG. 8 is a plot presenting a physical profile of the dried droplet (dome shaped, double humped curve) and intensity measurements of 4 line scans, across the image at 0, 45, 90, and 135 degrees across the image (Triple humped curves). FIG. 10 is a resulting plot of the data obtained from the experiment. The blue curve (top, open circles) represents sample spreading; the yellow curve (bottom, open circles) represents sample leveling; The solid lines overlaid onto the data represent modeling fits to the data.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Testing and analysis of the above-discussed systems and methods be performed using analog electronic circuitry, digital electronic circuitry, and/or in computer software, firmware, or hardware, including the structure disclosed in this specification and structural equivalents thereof, or in combinations of them. As appropriate, the subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, macro, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory (ROM) or a random access memory (RAM) or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, solid state drives, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Use of the terms “a,” “an,” and “the” herein are inclusive of plural of the nouns or noun equivalents to which they refer, unless context clearly dictates otherwise.

The terms “containing,” or “including,” in description of an article, device or method means that, as a minimum, the named apparatus, component, or procedure, etc. must be present in the article, device, or method. This does not preclude the presence of other material, article, element, or procedure, even if they are not specifically identified.

One skilled in the art will appreciate further features and advantages of the invention based on the above-described embodiments. Accordingly, the present application is not to be limited by what has been particularly shown and described, except as indicated by the claims. All publications and references cited herein are expressly incorporated by reference in their entirety.

1. A system for measuring sample spreading and leveling, comprising:
a substrate configured to receive a sample;
an illumination source configured to generate light incident upon a region of the substrate including the received sample;
a detector configured to measure intensity of the generated light that is reflected as a function of position and time;
a processor configured to:
receive the measured light intensity;
generate a first graphical image representing flatness of the sample as a function of position by:
comparing the measured intensity to a predetermined light intensity threshold value;
identifying first locations corresponding to measured light intensity that is greater than or equal to the predetermined light intensity threshold value as representing flat regions of the sample or substrate;
identifying second locations corresponding to measured light intensity that is less than the predetermined light intensity threshold value as representing non-flat regions of the sample;
generating the first graphical image presenting the first locations in a first color or pattern and the second locations in a second color or pattern different from the first color or pattern;
generate a second graphical image representing spreading of the sample as a function of time by:
identifying boundary positions at which the first and second locations are adjacent to one another at a plurality of times; and
generating the second graphical image presenting the identified boundary positions for at least two of the plurality of times; and
a display configured to display at least one of the first and second graphical images.

2. The system of claim 1, wherein the detector is further configured to measure the light intensity along a line oriented at a predetermined angle with respect to a plane of the substrate.

3. The system of claim 2, wherein the processor is further configured to generate the second graphical image representing the measured boundary as a function of position along the line.

4. The system of claim 3, further comprising a profilometer configured to measure a profile of the sample along the line;
wherein the processor is further configured to:
receive a profile measurement of the sample along the line; and
generate the second graphical image including the measured profile and the measured boundary.

5. The system of claim 1, further comprising a contact angle goniometer configured to measure a contact angle of the received sample concurrently with the measurement of light intensity.

6. The system of claim 1, further comprising at least one microlens array, the at least one microlens array being positioned in an optical path of the generated light or in an optical path of the reflected light.

7. The system of claim 1, wherein an angle of incidence of the incident light with respect to a normal of the substrate is within the range of about 0 degrees to 50 degrees.

8. The system of claim 1, wherein the light has a wavelength within the range from about 380 nm to about 800 nm.

9. The system of claim 1, wherein the light detector is a camera.

10. The system of claim 1, wherein the generated light is collimated.

11. The system of claim 1, wherein the generated light is coaxial.

12. The system of claim 1, further comprising a first objective lens positioned in an optical path of the generated incident light and a second objective lens positioned in an optical path of the reflected light.

13. The system of claim 1, further comprising a single objective lens positioned in an optical path of the generated incident light and an optical path of the reflected light.

14. A method for measuring sample spreading and leveling, comprising:
generating, by an illumination source, light incident upon a region of a substrate including a sample received thereon;
measuring, by a detector, intensity of the generated light that is reflected as a function of position and time;
receiving, by a processor, the measured light intensity;
generating, by the processor, a first graphical image representing flatness of the sample as a function of position by:
comparing the measured intensity to a predetermined light intensity threshold value;
identifying first locations corresponding to measured light intensity that is greater than or equal to the predetermined light intensity threshold value as representing flat regions of the sample or the substrate;
identifying second locations corresponding to measured light intensity that is less than the predetermined light intensity threshold value as representing non-flat regions of the sample;
generating the first graphical image presenting the first locations in a first color or pattern and the second locations in a second color or pattern different from the first color or pattern;
generating, by the processor, a second graphical image representing spreading of the sample as a function of time by:
identifying boundary positions at which the first and second locations are adjacent to one another at a plurality of times; and
generating the second graphical image presenting the identified boundary positions for at least two of the plurality of times; and
displaying, by a display, at least one of the first and second graphical images.

15. The method of claim 14, wherein the measured intensity is acquired along a line oriented at a predetermined angle with respect to a plane of the substrate.

16. The method of claim 15, wherein the method further comprises generating, by the processor, the second graphical image representing the measured boundary as a function of the position along the line.

17. The method of claim 16, further comprising:
measuring, by a profilometer, a profile of the sample along the line;
generating, by the processor, the second graphical image including the measured profile and the measured boundary.

18. The method of claim 17, further comprising measuring a contact angle of the received sample concurrently with the measurement of light intensity.

19. The method of claim 14, wherein an angle of incidence of the incident light with respect to a normal of the substrate is within the range of about 0 degrees to about 50 degrees.

20. The method of claim 14, wherein the light has a wavelength within the range from about 380 nm to about 800 nm.
